(19) United States
(12) Patent Application Publication
(10) Pub. No.: US 2011/0068502 A1
(43) Pub. Date: Mar. 24, 2011

(54) Custom Injection Mold and Molding Process Using Rapid Prototyping Processes

(76) Inventor: Stavros P. Basseas, Park Ridge, IL (US)

(21) Appl. No.: 12/604,110

(22) Filed: Oct. 22, 2009

Related U.S. Application Data
(60) Provisional application No. 61/244,212, filed on Sep. 21, 2009.

(51) Int. Cl. B29C 33/42; B22C 9/22; B29C 41/20

(52) U.S. Cl. 264/219; 249/55; 425/375

(57) ABSTRACT

A method of forming custom shaped injection molded parts from elastomeric materials includes using a rapid prototyping system to create a rigid, hollow, mold. The mold has a relatively thin, breakable, side wall. Elastomeric material can be injected into the mold and cured. The mold can then be broken to extract a cured elastomeric part.

### CROSS-REFERENCE TO RELATED APPLICATION

This application claims the benefit of the filing date of U.S. Provisional Application Ser. No. 61/244,212 filed Sep. 21, 2009 and entitled “Custom Injection Molded Mold Processing for the Fabrication of Custom Fit Foam Filled Sound Attenuating Ear Plugs for Hearing Protection and for the Fabrication of Custom Fit Soft Ear Mold for Hearing Protection From Noise With Active Components for Communication”. The '212 application is incorporated herein by reference.

### FIELD

The invention pertains to methods of manufacturing custom ear molds. More particularly, the invention pertains to such methods and associated products which incorporate rapid prototyping systems in fabricating the custom ear molds.

### BACKGROUND

Custom shaped ear pieces are regularly used throughout industries that include ear plug production, hearing protection, hearing aid manufacture, assisted listening device manufacture, and headphone products. Quite often hard plastic materials (>80 Shore A) are used to make the custom fit device; however, ear pieces from softer elastomeric materials (<80 Shore A) are also available and desirable. The processes for making elastomeric custom shaped ear pieces has existed in two basic forms:
1) Silicone Molds cast from a Hydrocolloid or Silicone Negative Molds,
2) Silicone Molds Cast in Multi Section Molds Produced on a Rapid Prototyping System.

The Silicone Mold method starts with a positive representation of the final object that has been created by one of two methods 1) a positive representation of the final shape which has been manually sculpted from a silicone ear impression, and 2) a positive representation of the final shape that was created from an scanned ear impression, has been electronically sculpted and then produced on a rapid prototyping machine.

The positive representation is placed in a tray with a barrier around it taller than the positive representation and a large opening on top for pouring material over the positive. The positive is then covered with a liquid material that fills in the volume around the positive shape, this liquid, when solidified, constitutes a negative mold. The liquid material for the negative or “duplicating” mold is typically a hydrocolloid, silicone or urethane material. These materials all have elastomeric properties in case the original positive shape has undercuts.

After the duplicating mold material has solidified the original positive is removed from the mold leaving a negative mold. In preparation for molding, often a mold release agent is added to the mold surface to prevent the elastomeric material from sticking to the mold—particularly if the mold and the filler material are similar in chemistry. Before the elastomeric material is added, mold “cores” can be inserted into the negative mold to create features in the new molded positive. These cores can create sound tubes or air vents in the molds, or possible cavities in the mold for other functions. But the complexity of such cores in regard to shape and placement is limited in this technology.

This mold is then filled with an elastomeric material to reform the positive shape in the elastomeric material. After the elastomeric material has solidified the positive piece is removed. At this point other features can be added to the mold by drilling, milling or grinding.

Disadvantages to the “Silicone Molds cast from a Hydrocolloid or Silicone Negative Molds” process when compared to the present Invention are:
1) the manual labor requirement in making the mold is higher,
2) there are more limitations of the core features that may be added to the mold in that it is difficult to place the cores in the proper orientation and the cores themselves cannot be of a complex shape, and
3) post processing of elastomeric materials with drills, routers and grinding bits is difficult and imprecise.

A method of using multi section molds for molding elastomeric earmolds again uses computer aided design software to create the positive. However, in this process the positive is then electronically subtracted from a larger pre-designed cavity, typically in the shape of a block or cube. After subtracting the positive form the mold block is electronically divided into sections, alignment features are added along with injection ports and air vents.

The various sections of the mold are then produced on a rapid prototyping system. After the sections are cleaned and cured they are polished to make a better mating surface between the mold block sections. Then the sections are assembled using the alignment features to form a closed cavity mold. Elastomeric material is injected into the mold. After the material solidifies the mold block is disassembled to release the finished article.

Disadvantages to this process are:
1) the mold block requires more rapid prototyping material than the proposed invention,
2) the mold surfaces are not flat due to the nature of the rapid prototyping technology and require either polishing or if left unpolished they will result in mold flash,
3) the alignment features will not be as precise as a one piece mold and therefore can cause distortion or flash in the finished article,
4) because the sections have to come apart the mold is limited in the type and complexity of the undercuts and features designed into the mold.

### BRIEF DESCRIPTION OF THE DRAWINGS

FIG. 1 illustrates a typical scan of ear impression scan captured using laser scanning technology (this is in STL file format);

FIG. 2 illustrates the electronic representation of the Final Molded Object after electronic sculpting in software;

FIG. 3 illustrates the electronic representation of the final molded object with the addition of a feature that will be use to create an injection port for molding;

FIG. 4 illustrates the comparison between the original sculpted object and the Offset Object that will comprise the exterior surface of the mold;

FIG. 5 illustrates the alignment between the Offset of the original sculpted object and the original sculpted object. It also shows how the original object completely lies within the Offset Object;

FIG. 6 illustrates a cross section of the Custom Injection Mold after the original sculpted object has been Boolean subtracted from the Offset Object and the injection port opening has been created;

FIG. 7 illustrates the addition of air vents to the Custom Injection Mold;

FIG. 8 illustrates the use of a static mixer and dispenser to inject elastomeric material into the Custom Mold Object. This shows the Custom Injection Mold after it has been created in a Rapid Prototyping System;

FIG. 9 illustrates the removal of the Custom Injection Mold material from the Final Injection Molded piece;

FIG. 10 illustrates the Final Injection Molded Piece with molding runners still attached;

FIG. 11 illustrates the Final Injection Molded Piece after runners have been removed;

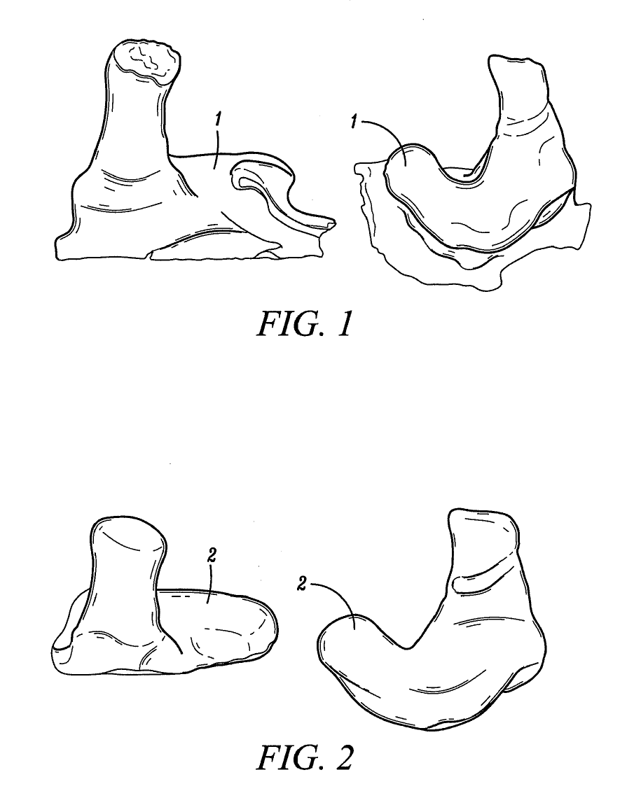

FIG. 1 illustrates a typical scan of ear impression scan captured using laser scanning technology (this is in STL file format);

FIG. 13 illustrates the electronic representation of the Final Molded Object after electronic sculpting in software. In this example the mold has complex elements added;

FIG. 14 illustrates the electronic representation of the final molded object with the addition of a feature that will be use to create an injection port for molding;

FIG. 15 illustrates the identification, selection and deletion of any design element of the sculpted object that will not be associated with the exterior surface of the Custom Injection Mold. It also shows any holes or voids created by the deletion are filled to reestablish the outer surface of the mold;

FIG. 16 illustrates the comparison between the original sculpted object and the Offset Object that will comprise the exterior surface of the mold;

FIG. 17 illustrates the alignment between the Offset of the original sculpted object and the original sculpted object. It also shows how the original object completely lies within the Offset Object;

FIG. 18 illustrates a cross section of the Custom Injection Mold after the original sculpted object has been Boolean subtracted from the Offset Object and the injection port opening has been created;

FIG. 19 illustrates the addition of air vents to the Custom Injection Mold;

FIG. 20 illustrates the removal of the Custom Injection Mold material from the Final Injection Molded piece;

FIG. 21 illustrates the removal of the Custom Injection Mold material that constitutes the interior cores of the mold from the Final Injection Molded piece;

FIG. 22 illustrates the Final Injection Molded Piece with molding runners still attached;

FIG. 23 illustrates the Final Injection Molded Piece after runners have been removed;

FIGS. 24A,B taken together illustrate aspects of the method of the present invention; and

FIG. 25 is a block diagram of a system in accordance with the invention.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

Embodiments of the invention represent improvements in making injection molds of the type discussed here, particularly for, but not exclusive to, the molding of elastomeric materials. Computer Aided Design software and Rapid Prototyping (RP) equipment are used in combination creating a useful process for making custom shaped articles for various applications such as hearing aids, medical prosthesis and dental articles, but the articles produced on rapid prototyping equipment are limited to non-elastomeric materials. However, using methods in accordance herewith, including the use of CAD software and then fabricating an injection mold on RP equipment, a useful, single use, custom shaped injection mold can be created for the use in the injection molding of elastomeric materials.

Embodiments of the invention are applicable to the ear mold industry in particular, but any industry requiring elastomeric parts of complex custom molded shapes could benefit. The molds for the elastomeric parts are designed using automated software procedures and then fabricated on a Rapid Prototyping System such as Fused Deposition Modeling (FDM), Digital Light Projection (DLP), Stereolithography (SLA), Selective Laser Sintering (SLS), Three Dimensional Printing (3DP), and Inkjet Modeling (examples include Objet) using a plastic material. After the mold has been fabricated it can be filled with any type of elastomeric material. After curing the material the part is released from the mold by breaking it open. The mold can be used only one time.

In one aspect of the invention, the process starts with a 3D image of the shape to be produced this is referred to as the “original positive”. The “original positive” is manipulated in software to create a “larger positive”. The “original positive” is then subtracted from the “larger positive” to create a thin walled mold with an interior mold cavity called the “one-time mold”.

The “one-time mold” is produced on any rapid prototyping system such as the ones listed above. When the mold is finished an elastomer is injected into the mold and allowed to cure according to the recommendations of the material manufacturer. After the elastomer cures the mold is broken open and peeled off the molded article similar to peeling the shell off a hard boiled egg. Advantageously, the process can be used to create molded articles of complex shapes that include under cuts, inserted mechanical objects, and more than one material.

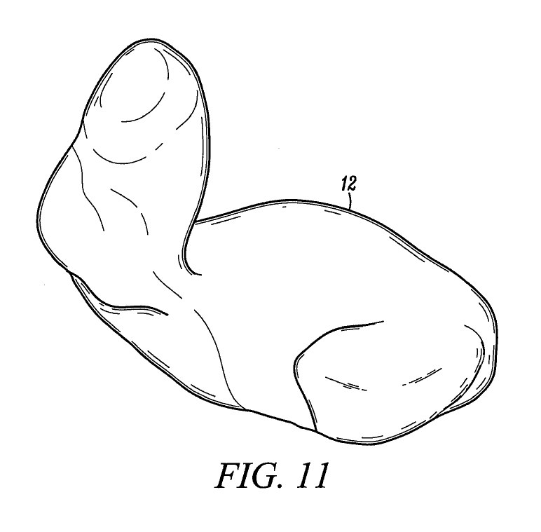

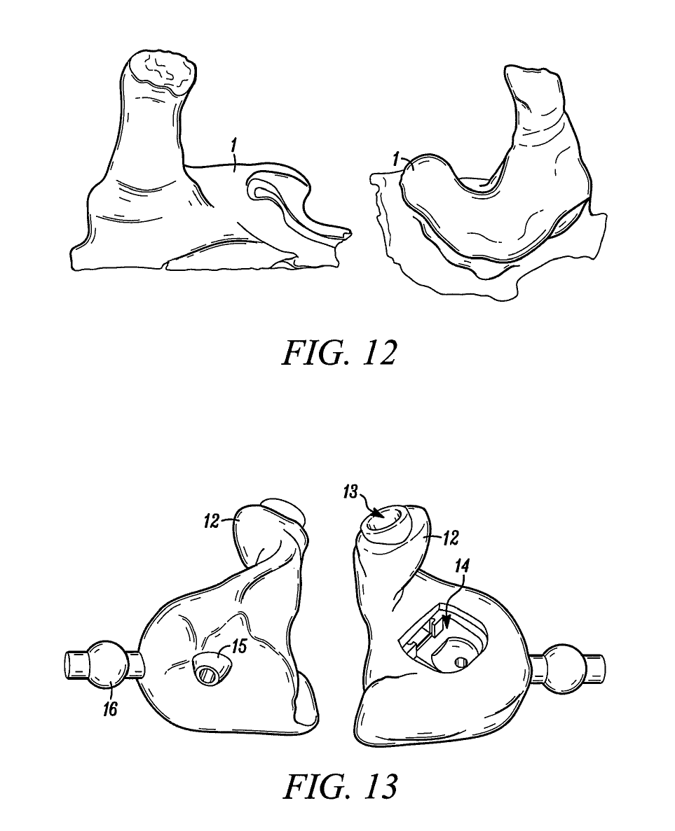

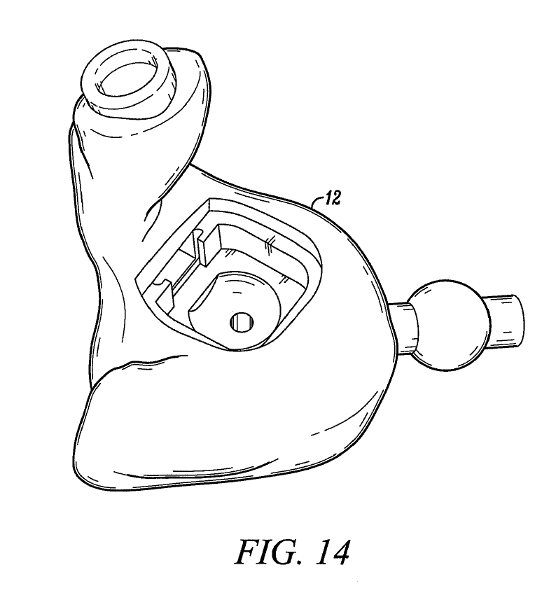

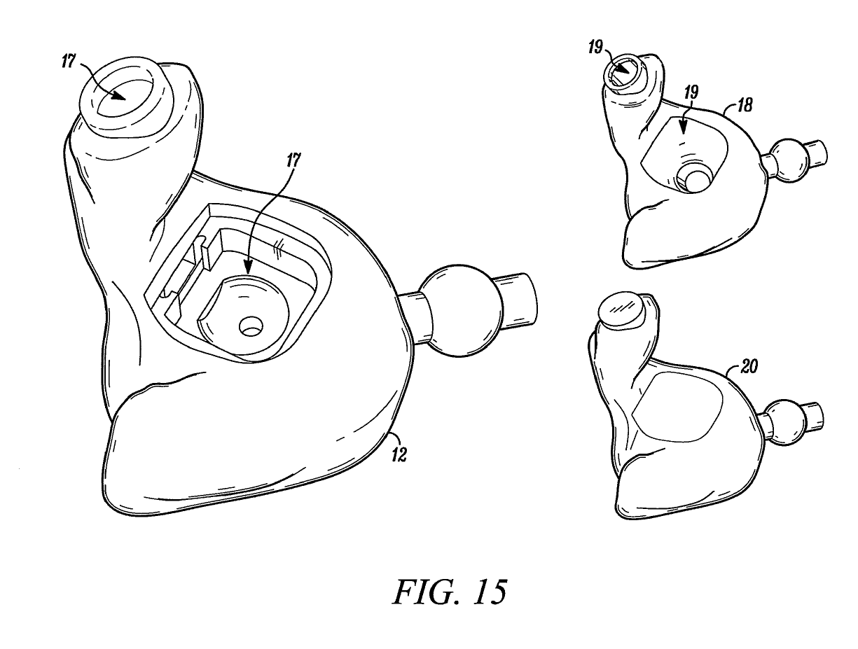

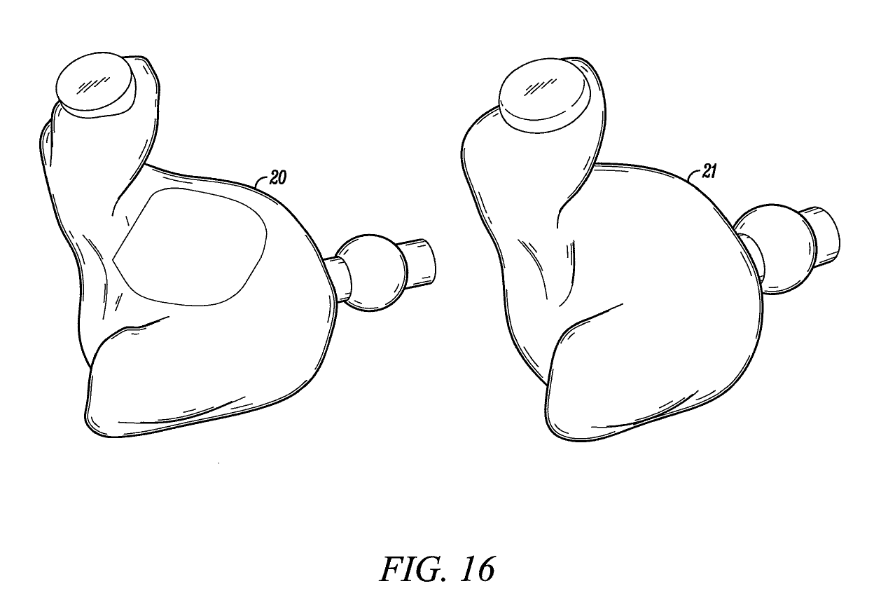

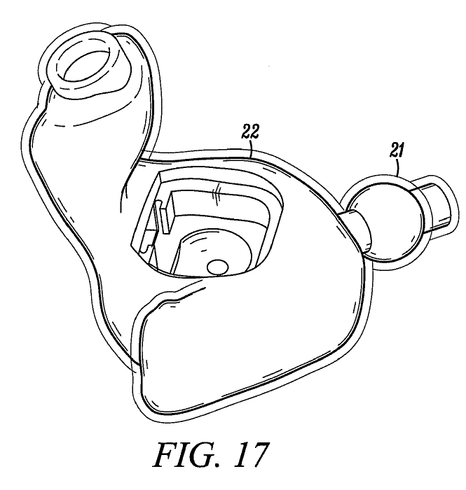

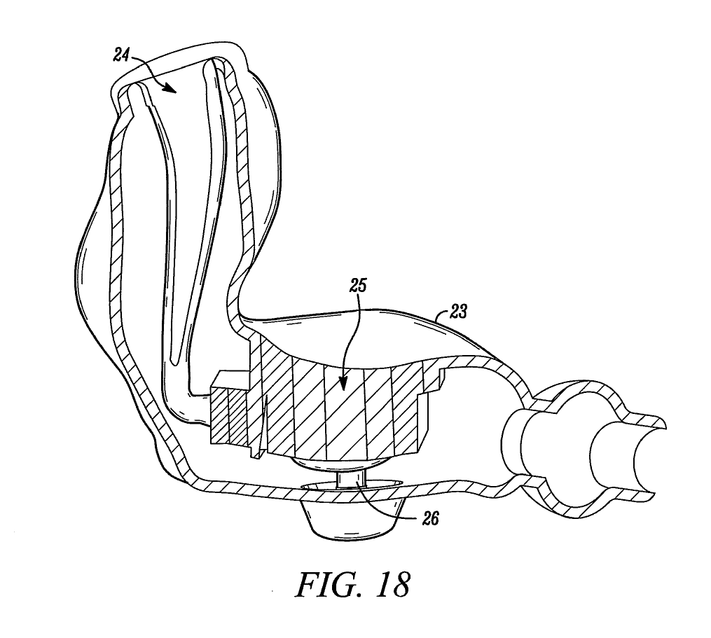

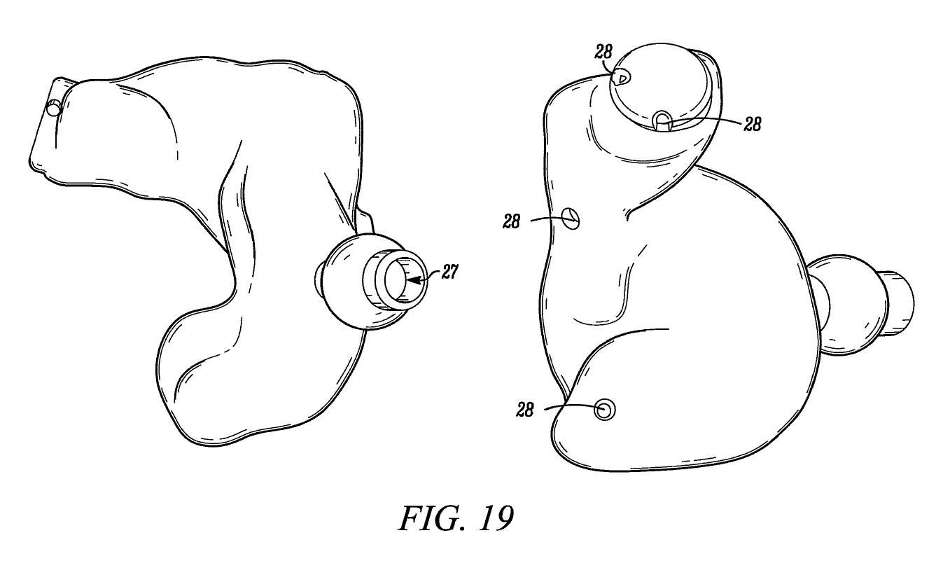

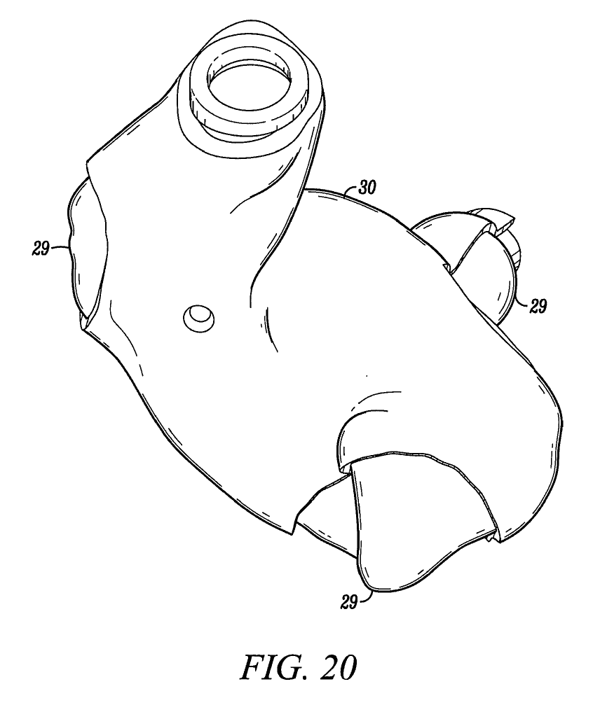

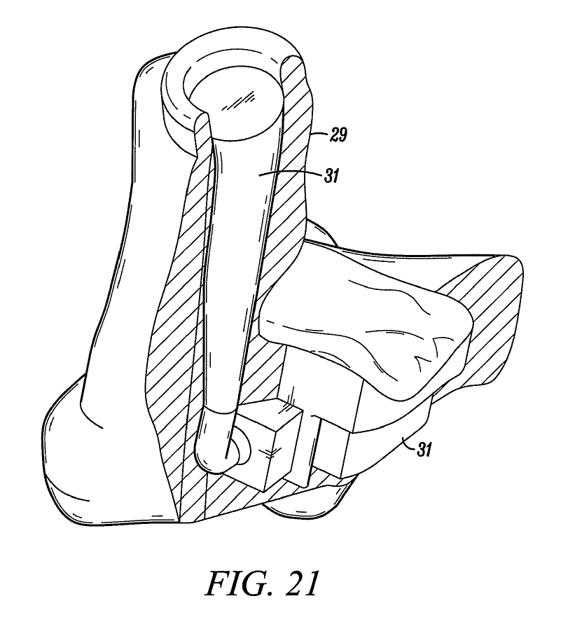

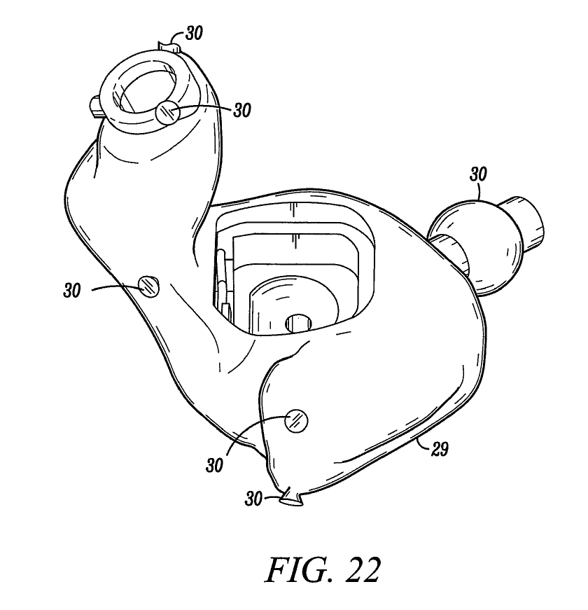

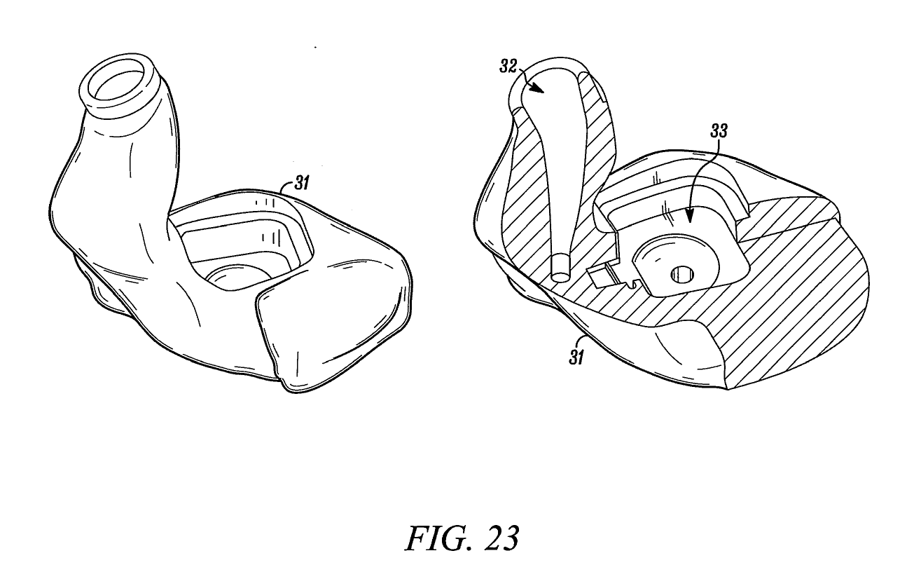

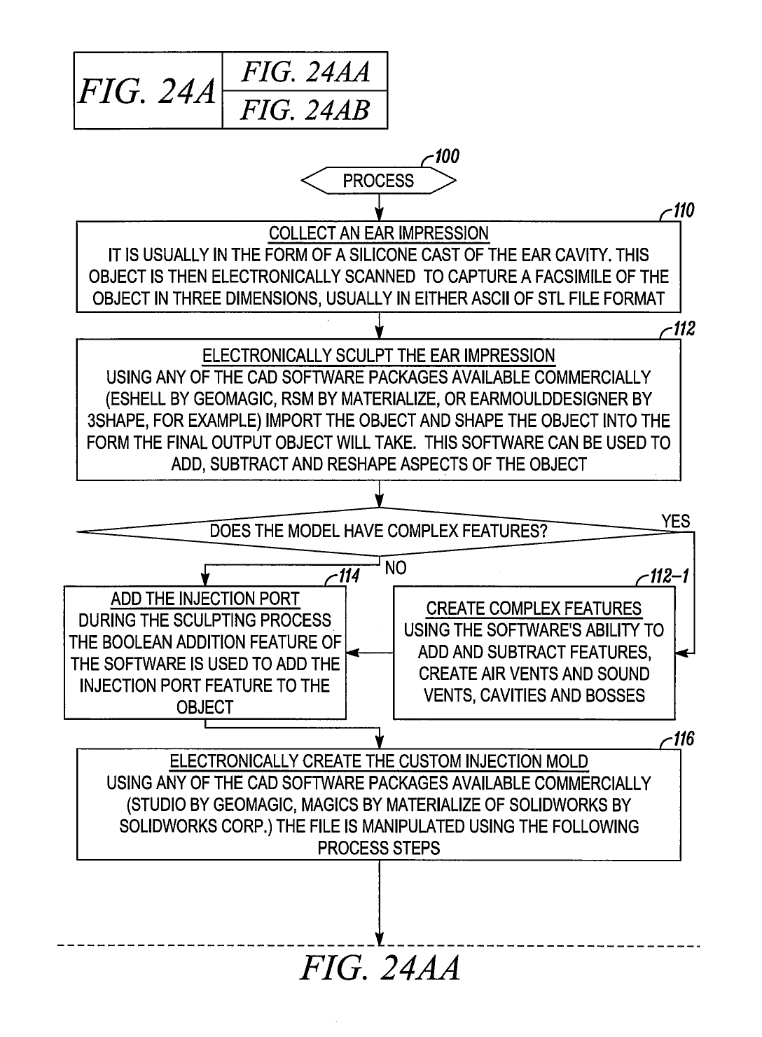

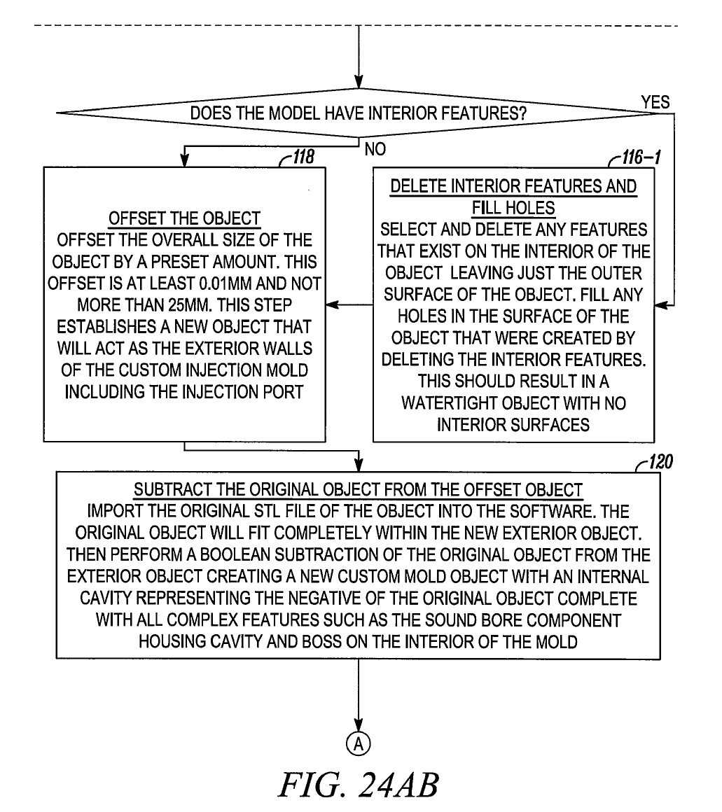

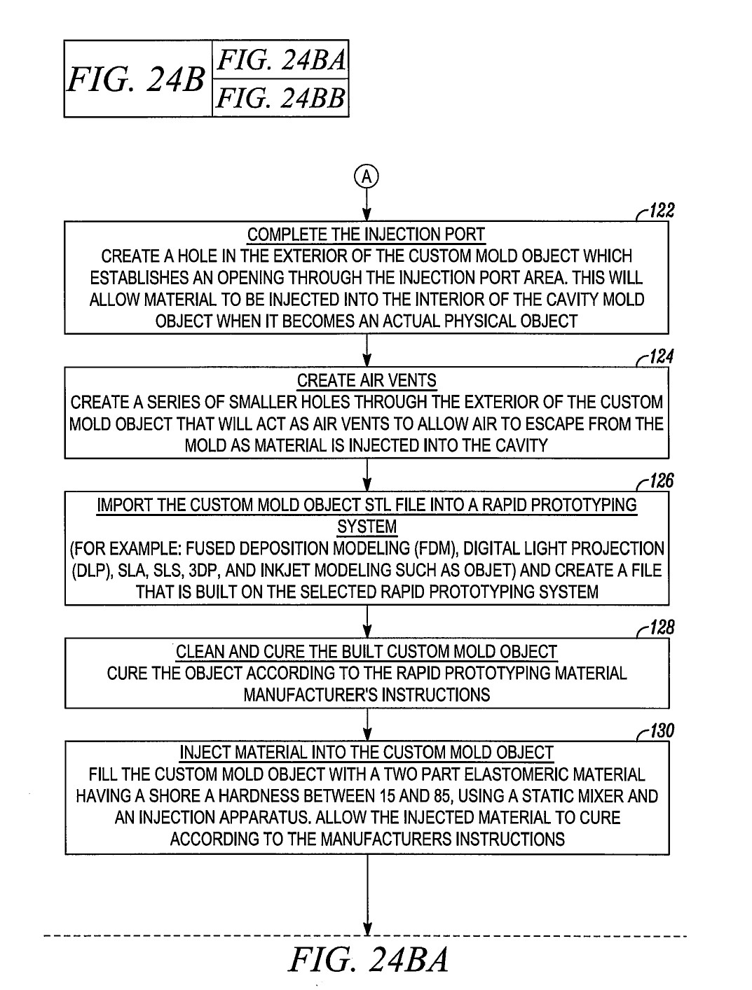

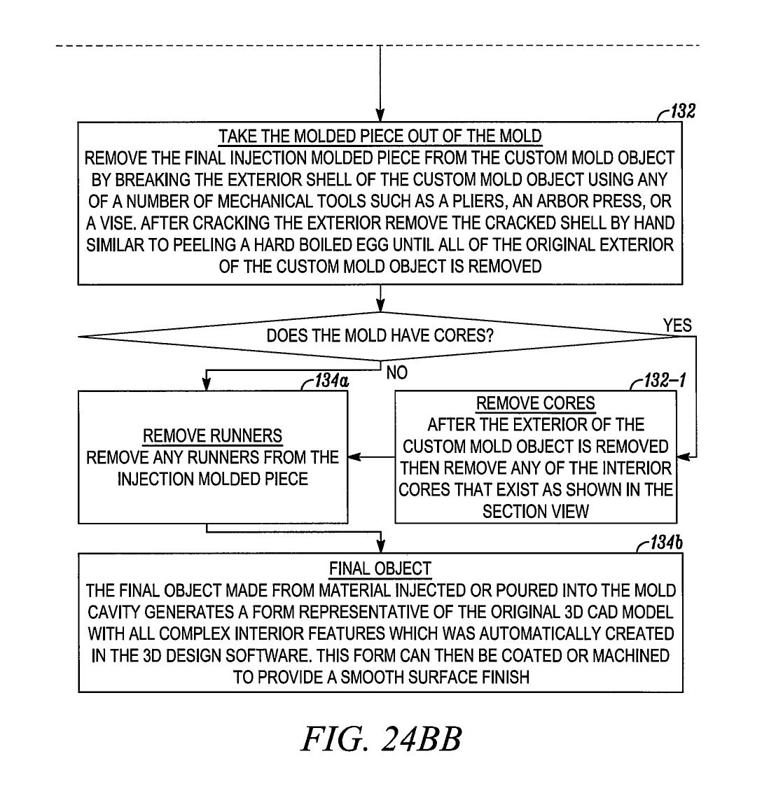

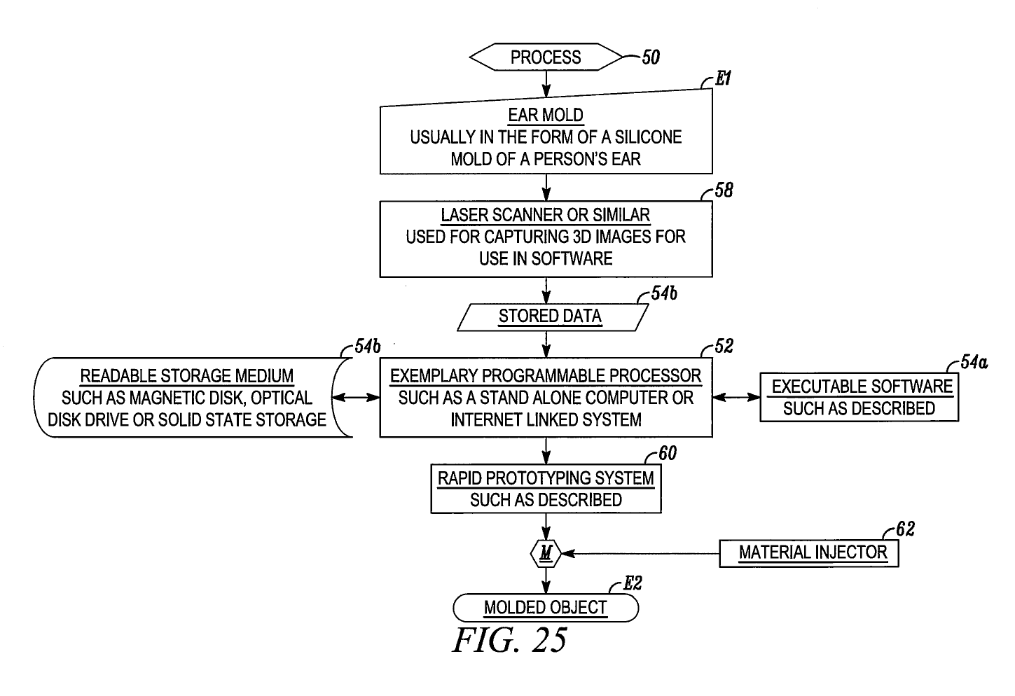

Aspects of a process 100 will now be described with respect to FIGS. 1-11 and 24A,B. This process will form a mold without interior features. With respect to the figures, Step 110, FIG. 1 in the process requires capturing a custom shape—in this case an ear impression. An ear impression (1) is usually in the form of a silicone cast of the ear cavity. This object is then electronically scanned to capture a facsimile of the object in three dimensions, usually in either ASCII or STL file format. As those of skill in the art will understand, other formats could be used without departing from the spirit and scope of the invention.

Step 112, FIG. 2, electronically sculpt the object. Using any of the CAD software packages available commercially (eShell by Geomagic, RSM by Materialize, or EarMouldDesigner by 3Shape, for example) import the object and shape the object into the form the final output object will take (2). This software can be used to add, subtract and reshape aspects of the object.

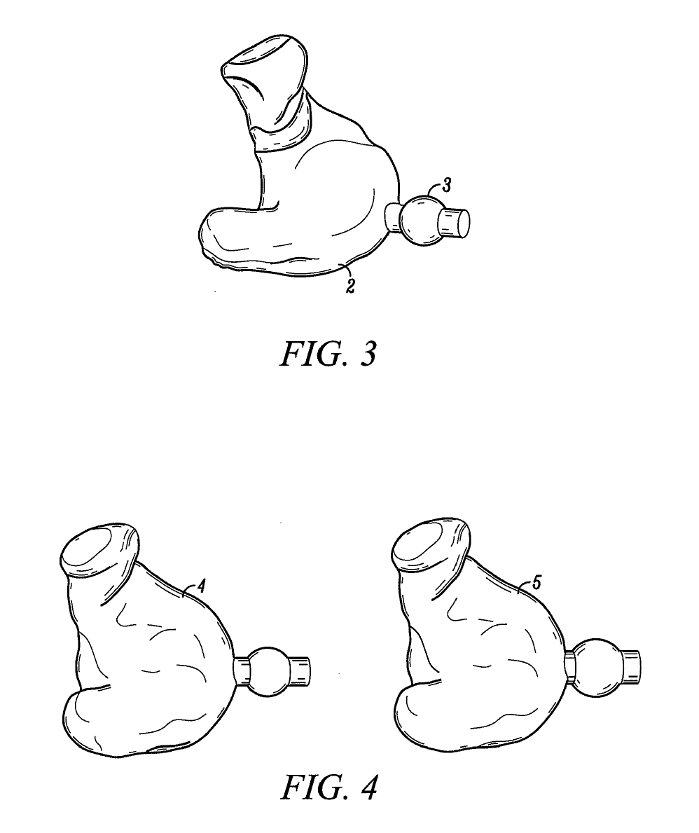

Step 114, FIG. 3, electronically sculpt the object (2) by adding a feature to act as the material injection port. During the sculpting process the Boolean Addition feature of the software can be used to add the injection port feature (3) to the object (2) then save the Object in STL file format.

Step 116, FIG. 4, electronically prepare the Custom Injection Mold. Import the STL file of the object into the software and then, using any of the CAD software packages available commercially (Studio by Geomagic, Magics by Materialize or Solidworks by Solidworks Corp.), the file is manipulated, automatically or manually, as would be understood by those of skill in the art.

Step 118, FIG. 4, electronically prepare the Custom Injection Mold by creating an offset. Offset the overall size of the object (4) by a preset amount. This offset is preferably at least 0.01 mm and not more than 25 mm. This step establishes a new object (5) that will act as the exterior walls of the Custom Injection Mold including the injection port.

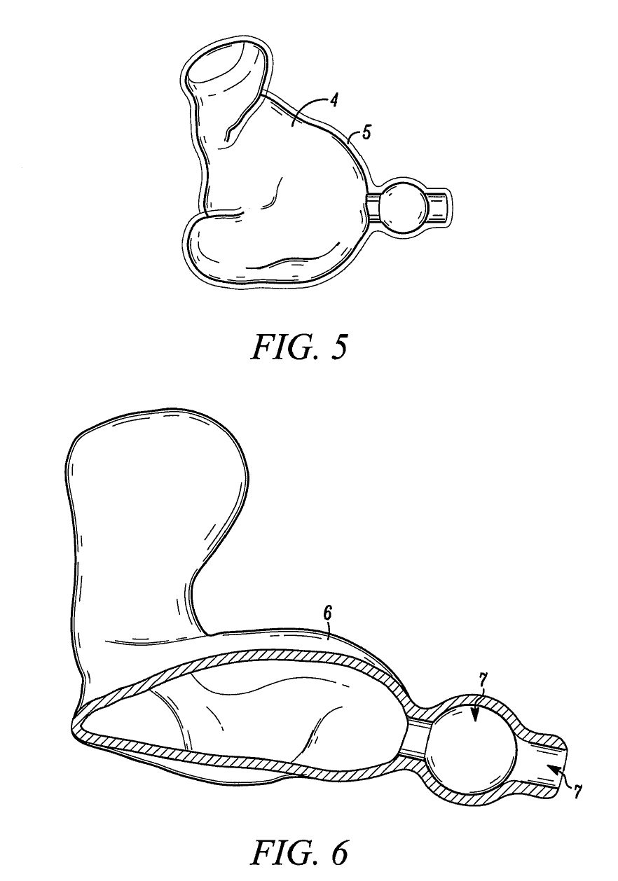

Step 120, FIGS. 5 & 6, electronically prepare the Custom Injection Mold by subtracting the original file from the offset file. Import the original STL file of the object (4) into the offset file (5). The original object will fit completely within the new Exterior object (5). Then perform a Boolean subtraction of the original object from the Exterior object creating a new Custom Mold object with an internal cavity representing the negative of the original object (6).

Step 122, FIG. 6, electronically prepare the Custom Injection Mold by adding a hole for the injection port. Create a hole in the exterior of the Custom Mold Object (6) which establishes an opening through the injection port area (7). This will allow material to be injected into the interior of the Cavity Mold Object when it becomes an actual physical object.

Step 124, FIG. 7, electronically prepare the Custom Injection Mold by creating air vents. Create a series of smaller holes through the exterior of the Custom Mold Object that will act as air vents (8) to allow air to escape from the mold as material is injected into the cavity through the injection port (7). Step 124 will electronically prepare the Custom Injection Mold by Saving the Custom Mold Object in STL file format.

Step 126, build the Custom Mold Object using Rapid Prototype Production. Import the Custom Mold Object STL file into any type of Rapid Prototyping System (for example: Fused Deposition Modeling (FDM), Digital Light Projection (DLP), SLA, SLS, 3DP, and Inkjet Modeling such as Objet) and create a file that can be built on the selected Rapid Prototyping System.

After building the Custom Mold Object, as at 126, on the machine clean and cure the built Custom Mold Object according to the rapid prototyping material manufacturers instructions, as at 128. Preferably, the interior of the mold will be fully cured to prevent any chemical interaction between the rapid prototyping material and the injection molding material.

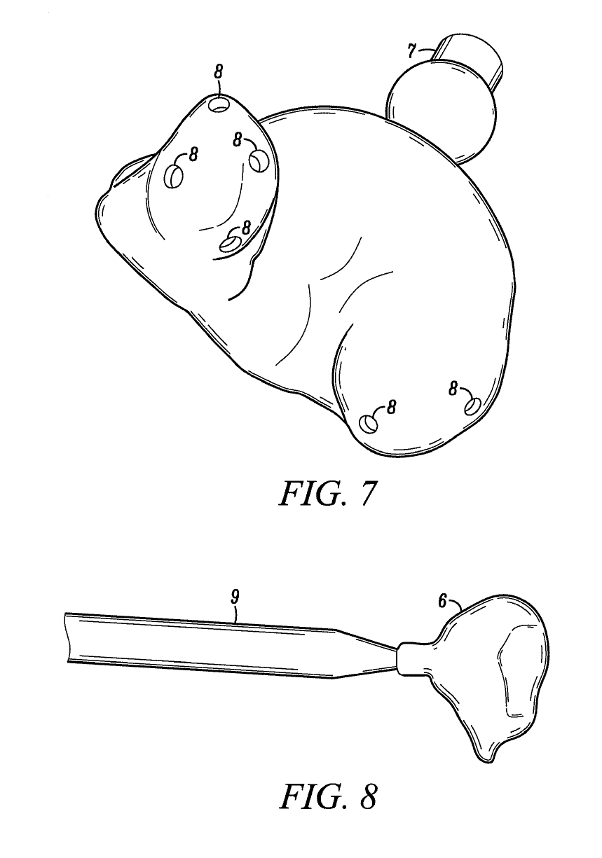

Step 130, FIG. 8, perform the injection Mold Process using the Custom Mold Object. Fill the Custom Mold Object (6) with, for, example, a two part elastomeric material having a Shore A hardness between 15 and 85, using a static mixer (9) and an injection apparatus. Allow the injected material to cure according to the manufacturers instructions.

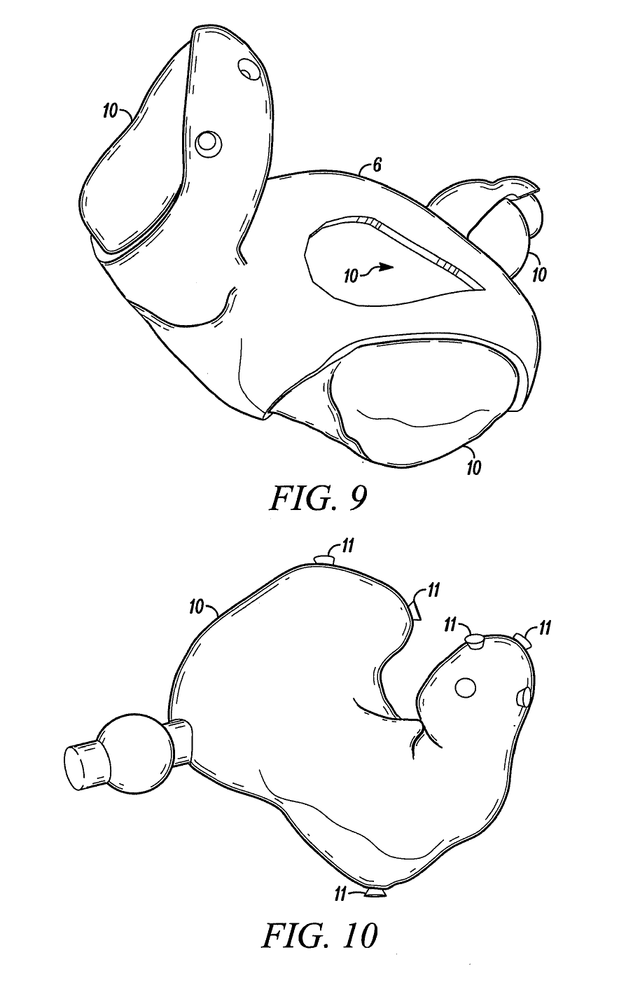

Step 132, FIG. 9, Remove the Injected Material from the Custom Mold Object. Remove the final injection molded piece (10) from the Custom Mold Object (6) by breaking the exterior shell of the Custom Mold Object using any of a number of mechanical tools such as pliers, an arbor press, or a vise. After cracking the exterior remove the cracked shell by hand similar to peeling a hard boiled egg until the entire original exterior of the Custom Mold Object is removed.

Steps 134a,b FIGS. 10 & 11, Final Object Preparation. Remove the runners (11) from the injection molded piece (10). The final object (12) made from material injected or poured into the mold cavity generates a form representative of the original 3D CAD model (FIG. 2, (2)) which was automatically created in the 3D design software. This form can then be coated or machined to provide a smooth surface finish.

In another aspect of the process 100, in accordance with the invention, a mold can be formed with multiple interior features. Referring again to the figures, Step 110, FIG. 12, in the process requires capturing a custom shape—in this case an ear impression. An ear impression (1) is usually in the form of a silicone cast of the ear cavity. This object is then electronically scanned to capture a facsimile of the object in three dimensions, usually in either ASCII of STL file format.

Step 112 FIG. 13, electronically sculpt the object by using any of the CAD software packages available commercially (eShell by Geomagic, RSM by Materialize, or EarMouldDesigner by 3Shape, for example). Import the object and shape the object into the form the final output object will take (12). This software can be used to add, subtract and reshape aspects of the object.

Step 112-1, FIG. 13, electronically sculpt the object by making complex feature additions. Using the software's ability to add and subtract features, complex features can be added to or subtracted from the mold interior and exterior. For example air vents and sound vents (13) that are potentially curved, have changing diameters and are not round in shape. Cavities (14) and bosses (15) can be added that function as packaging sites or strain relief for electronic or mechanical components. During the sculpting step the Boolean Addition feature of the software is used to add the injection port feature (16) to the object. The Object can then be saved in STL file format or any other desired format.

Step 116, FIG. 14, electronically prepare the Custom Injection Mold by importing the STL file of the object (12) into the software using any of the CAD software packages available commercially (Studio by Geomagic, Magics by Materialize of Solidworks by Solidworks Corp.) the file is manipulated manually or automatically using the following process steps

Step 116-1, FIG. 15, electronically prepare the Custom Injection Mold by deleting interior features and closing holes. Select and delete any features that exist on the interior of the object (17) leaving just the outer surface of the object (18). Then fill any holes (19) in the surface of the object that were created by deleting the interior features. This should result in a watertight object with no interior surfaces (20).

Step 118, FIG. 16, electronically prepare the Custom Injection Mold by offsetting the exterior surface. Offset the overall size of the object (20) by a preset amount. This offset is, preferably, at least 0.01 mm and not more than 25 mm. This step establishes a new object (21) that will act as the exterior walls of the Custom Injection Mold including the injection port.

Step 120, FIGS. 17 & 18, electronically prepare the Custom Injection Mold by subtracting the original file from the offset file. Import the original STL file of the object (22) into the software. The original object will fit completely within the new Exterior object (21). Then perform a Boolean subtraction of the original object from the Exterior object creating a new Custom Mold object (23) with an internal cavity representing the negative of the original object complete with all complex features such as the sound bore (24), component housing cavity (25) and boss (26) on the interior of the mold.

Steps 122, 124 FIG. 19, electronically prepare the Custom Injection Mold by creating a hole in the exterior of the Custom Mold Object which establishes an opening (27) through the injection port area. This will allow material to be injected into the interior of the Cavity Mold Object when it becomes an actual physical object. Create a series of smaller holes (28) holes through the exterior of the Custom Mold Object that will act as air vents to allow air to escape from the mold as material is injected into the cavity. Save the Custom Mold Object in STL file format.

Step 126, build the Custom Mold Object using Rapid Prototype Production. Import the Custom Mold Object STL file into any type of Rapid Prototyping System (for example: Fused Deposition Modeling (FDM), Digital Light Projection (DLP), SLA, SLS, 3DP, and Inkjet Modeling such as Objet) and create a file that is built on the selected Rapid Prototyping System.

Step 128, after building the object on the rapid prototyping machine, clean and cure the built Custom Mold Object according to the rapid prototyping material manufacturers instructions. Care must be taken to fully cure the interior of the mold to prevent any chemical interaction between the rapid prototyping material and the injection molding material.

Step 130, FIG. 8, then perform the Injection Mold Process using the Custom Mold Object. Fill the Custom Mold Object with a two part elastomeric material having a Shore A hardness between 15 and 85, using, for example, a static mixer and an injection apparatus. Allow the injected material to cure according to the manufacturers instructions

Step 132, 132-1, FIGS. 20 & 21, remove the final injection molded piece (29) from the Custom Mold Object (30) by breaking the exterior shell of the Custom Mold Object using any of a number of mechanical tools such as pliers, an arbor press, or a vise. After cracking the exterior remove the cracked shell by hand similar to peeling a hard boiled egg until the entire original exterior of the Custom Mold Object is removed. After the exterior of the Custom Mold Object is removed then remove any of the interior cores (31) that exist inside the final injection molded piece (29) as shown in the section view.

Steps 134a,b FIGS. 22 & 23, Final Object Preparation requires the removal of any runners (30) from the injection molded piece (29). The final object (31) made from material injected or poured into the mold cavity generates a form representative of the original 3D CAD model (FIG. 13 (12)) with all complex interior features such as sound tubes (32) and cavities (33) which were automatically created in the 3D design software. This form can then be coated or machined to provide a smooth surface finish.

FIG. 25 illustrates a block diagram 50 in accordance with the present invention. System 50 includes an exemplary programmable processor 52 with an associated computer readable storage medium, such as a magnetic or optical disk drive or solid state storage circuits 54. Processor 52 can be part of a stand alone computer system, an internet linked system or part of a wireless communication system.

Executable software 54a, corresponding to various of the software packages discussed above, can be stored in executable form in the computer readable medium 54, loaded into processor 52 and executed in carrying out the various previously discussed processing steps. The storage unit 54 can also store data 54b, which could be person specific, or include parameters for use in molding as discussed above. All such data 54b could be uploaded to processor 52 as needed as would be understood by those of skill in the art.

System 50 can also include a scanner 58 coupled to the processor 52. Scanner 58 can be of a type which can directly scan an individual's ear and provide a digital representation thereof to processor 52. Alternately, scanner 58 can scan a pre-created ear mold E1, of a conventional variety, of the individual's ear.

The processor 52 is coupled to a rapid prototyping system 60, such as discussed above, which responds to commands and data from processor 52 to produce a substantially rigid, hollow mold M as discussed above. A manual, or, automatic injector 62 can be used to inject uncured elastomeric material into the hollow mold M. Once the elastomeric material has been cured, the mold M can be broken open and the customized ear plug E2 removed. If needed, the system 60 could be used to create a duplicate of the mold M for later use.

Those of skill will understand that while embodiments of the invention have been described with respect to various commercial products and software, such are exemplary only. None of the exact details of such products or software represent limitations of the present invention. It will also be understood that various computer system configurations come within the spirit and scope of the invention. Such variations include, portable or PC based systems, networked systems, internet based systems, or wireless communications/telephony systems all without limitation.

Advantages of processes in accordance with the invention include:

That the use of this process including the use of 3D software will automatically generate a cavity mold with the correct placement of the injection port. Once this mold is generated and injected or filled with a heat curable, moisture curable or light curable material and the cavity is removed, the part will be an exact or approximate representative of the original 3D CAD model.

The apparatus can be used to making any variety of complex custom shapes from elastomeric materials injected into the Custom Injection Mold, these include but are not limited to ear molds for hearing protection, hearing device adaptation and personalized sound transmission devices.

The development of a thin walled “one time mold” constitutes a unique process for creating injection molded parts. Using an ear impression in ASCII or STL file format in conjunction with any of the CAD software packages available commercially (eShell by Geomagic, RSM by Materialize, or EarMouldDesigner by 3Shape, for example) A 3D object can be created that represents the final elastomeric device. This device may contain complex features which are added to or subtracted from the mold interior and exterior. For example air vents and sound vents that are potentially curved, have changing diameters and are not round in shape. Cavities and bosses can be added that function as packaging sites for electronic or mechanical components. One of these features is a specially designed material injection port.

Using any of the CAD software packages available commercially (Studio by Geomagic, Magics by Materialize of Solidworks by Solidworks Corp.) the file is manipulated using the defined process steps. In this application the automation of these software functions is proposed—the automation of these functions does not currently exist.

This process includes the selection and deletion of any features that exist on the interior of the object. All holes in the surface of the object that were created by deleting the interior features are subsequently filled resulting in a watertight object with no interior surfaces. The object is offset in the overall size by a preset amount that is at least 0.01 mm and not more than 25 mm. This step establishes a new object that will act as the exterior walls of the Custom Injection Mold including the injection port.

The original object completely fits within the new Exterior object and is then Boolean subtracted from the Exterior Object creating a new Custom Mold object with an internal cavity representing the negative of the original object complete with all complex features such as the sound bore component housing cavity and boss on the interior of the mold.

A hole in the exterior of the Custom Mold Object establishes an opening through the injection port area. This will allow material to be injected into the interior of the Cavity Mold Object when it becomes an actual physical object. The creation of a series of smaller holes through the exterior of the Custom Mold Object will act as air vents to allow air to escape from the mold as material is injected into the cavity.

The cavity can be built using an additive process such as Fused Deposition Modeling (FDM), Digital Light Projection (DLP), Stereolithography (SLA), Selective Laser Sintering (SLS), Three Dimensional Printing (3DP), and Inkjet Modeling (examples include Object).

The Custom Mold Object can be filled with a two part elastomeric material having a Shore A hardness between 15 and 85, using a static mixer and an injection apparatus.

The elastomeric part can be removed from the mold by cracking or dissolving the cavity rendering the mold unusable more than one time.

The material injected or poured into the mold cavity generates a form representative of the original 3D CAD model which was automatically created in the 3D design software. This form can then be coated to provide a smooth surface finish.

This process constitutes a simple method over prior art such as a multi-section mold. The creation of a continuous one piece mold has advantages over the prior art of a multi-section mold in that it:
1) eliminates the need for alignment features between sections,
2) it eliminates the need for smooth surfaces to create tight mating lines for preventing flash, and
3) it prevents any flash from occurring during the molding process.

This process, in that it creates a one piece mold, eliminates the need to clamp mold sections together in an attempt to form a tight seal between sections. While this renders the mold unusable for more than this one molded piece, there is no mold to clean or reconstruct. Additional pieces are made by the creation of additional molds.

In this process the complex features and cores can be placed anywhere without consideration of their location in regard to parting lines, since there are no parting lines in the mold. Additionally, there is no mold flash to remove in this process.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A method comprising:
establishing a representation of a shape of an ear cavity;
forming a second representation of the shape of the ear cavity wherein the second representation is larger than the representation by a predetermined amount;
deleting interior material from the second representation in accordance with the shape of the representation thereby producing a substantially hollow region in the second representation;
filling the hollow region, at least in part, with an elastomeric material;
and curing the elastomeric material to form an elastomeric object.

2. A method as in claim 1 which includes installing components in the elastomeric object.

3. A method as in claim 1 which includes filling at least a portion of the hollow region with a second, different material.

4. A method as in claim 1 where the elastomeric object comprises one of a sound enhancing ear plug, or, an acoustic protective ear plug.

5. A method as in claim 1 which includes establishing selective features in the second representation.

6. A method as in claim 1 where the representation comprises one of a physical representation of an ear cavity, or, an electronic representation of an ear cavity.

7. A method as in claim 6 which includes converting the physical representation to an electronic model of an ear cavity.

8. A method as in claim 7 which includes enlarging the electronic model the predetermined amount to form the secondary representation.

9. A method as in claim 8 which includes canceling the electronic model from the second representation.

10. A method as in claim 9 which includes incorporating selected features into the secondary representation.

11. A method as in claim 1 where deleting includes providing a substantially rigid mold with an interior surface corresponding to the shape of the representation and a wall thickness which corresponds to the predetermined amount.

12. A method as in claim 11 which includes breaking the mold, at least in part, and extracting the elastomeric object therefrom.

13. A method as in claim 11 which includes filling a part of the hollow region with internal feature defining extensions of the rigid mold.

14. A method as in claim 13 which includes surrounding the feature defining extensions, at least in part, with the elastomeric material prior to curing that material.

15. A method as in claim 14 which includes extracting the surrounded feature defining extensions from within the elastomeric material.

16. A method as in claim 15 where extracting includes temporarily distorting the elastomeric object to remove at least parts of the extensions.

17. A method as in claim 11 where providing includes using a rapid prototyping process in creating the rigid mold.

18. An element comprising:
a hollow, rigid shell with an interior surface which replicates a selected interior portion of an individual's ear;
an elastomeric member, contained substantially within the shell where an external surface of the member abuts and is in contact with at least portions of the interior surface of the shell, where portions of the shell extend into the elastomeric member and are surrounded thereby, at least in part.

19. An element as in claim 18 where the shell is breakable and the member is extractable therefrom.

20. An element as in claim 19 where the portions of the shell are removable from the elastomeric member and where the member, after removal of the portions of the shell, includes an interior acoustic path.

21. An element as in claim 19 which includes at least one component receiving region molded into the member.

22. An element as in claim 21 where the component receiving region is substantially surrounded by the member.

23. An element as in claim 19 where at least one portion of the member is spaced from a body portion of the member and an intervening region is substantially filled by a portion of the shell.

24. An element as in claim 23 where the portion of the shell filling the intervening region is removable.

25. A system comprising:
first circuits to obtain a digital representation of an ear cavity;
second circuits to obtain an enlarged second digital representation of the ear cavity from the first representation; and
circuitry to produce a hollow, rigid mold from the second digital representation wherein an interior surface of the mold corresponds to a surface of the ear cavity.

26. A system as in claim 25 which includes an apparatus to inject a curable elastomer into the hollow rigid mold.

27. A system as in acclaim 25 which includes an electronic storage device coupled to the first and second circuits.

28. A system as in claim 27 where the storage device is selected from a class which includes, at least, a magnetic storage device, an optical storage device, or a semiconductor storage device.

29. A system as in claim 25 where the circuitry to produce includes a rapid prototyping system.

30. A system as in claim 29 which includes an apparatus to inject a curable elastomer into the hollow rigid mold.

31. A system as in claim 25 where the first and second circuits comprise a programmable processor.

32. A system as in claim 25 where the first circuits comprise a scanner.

33. A system as in claim 25 which includes control circuits to locate selected features on, or in the enlarged second representation of the ear cavity.

34. A system as in claim 33 where the selected features include at least one of a component receiving cavity, or an audio path.

35. A system as in claim 25 where the second circuits include circuits to remove the first representation from the second representation thereby forming a hollow shell representation having a selected wall thickness.

36. A system as in claim 25 where the circuitry to produce creates the hollow rigid mold in response to the hollow shell representation.
